(19) United States
(12) Patent Application Publication
(10) Pub. No.: US 2016/0002398 A1
(43) Pub. Date: Jan. 7, 2016

(54) Novel Method for Purifying Polyesters

(71) Applicant: IPSEN PHARMA S.A.S., Boulogne Billancourt (FR)

(72) Inventors: Didier BOURISSOU, Plaisance du Touch (FR); Blanca MARTIN-VACA, Toulouse (FR); Olivier THILLAYE DU BOULLAY, Montans (FR)

(21) Appl. No.: 14/770,357

(22) PCT Filed: Feb. 25, 2014
(86) PCT No.: PCT/EP2014/053600

§ 371 Date: Aug. 25, 2015

(30) Foreign Application Priority Data
Feb. 26, 2013 (FR) 1351657

(51) Int. Cl. C08G 63/90; C08G 63/08; C08G 63/06

(52) U.S. Cl. CPC C08G 63/90; C08G 63/06; C08G 63/08

(57) ABSTRACT

The invention relates to a method for purifying a polyester including impurities, said impurities including at least 0.1% by weight of a polyester or of residual monomer(s), including at least one step of: (ii) adding, to the polyester in a solvent, a functionalized material selected between a PAMAM dendrimer and a resin functionalized by one or more primary and/or secondary amine functions. Said method enables a low level of residual monomer(s) to be obtained while providing economically and environmentally advantageous reaction conditions.

The present invention relates to a new process for purification of polyesters containing impurities. The present invention also relates to a new polyester preparation process.

Nowadays, increasing attention is paid to synthetic polymers for the development of artificial organs and drug formulation [Chem. Eng. News 2001, 79 (6), 30]. The polymers concerned must meet a number of criteria and, in particular, they must be biocompatible. Biodegradability is an additional advantage if the polymer has to be eliminated after an appropriate period of implantation in an organism. In this regard, polyesters, and particularly copolymers based on lactic and glycolic acid (PLGA) are of very great interest because they are susceptible to hydrolysis and are degraded in vivo with release of non-toxic by-products. The field of application of PLGA is very wide (Adv. Mater. 1996, 8, 305 and Chemosphere 2001, 43, 49). In the surgical field, they are used for synthesis of multi-strand threads, sutures, implants, prostheses, etc. In pharmacology, they allow the encapsulation, the transfer and the controlled release of active principles.

Generally, however, the stability of these polyesters may be impaired by the presence of impurities, particularly residual monomer. These impurities result from the process of synthesis of these polyesters.

More particularly, the stability of polymers for medical applications is essential in order to limit as far as possible the premature degradation of the system and the harmful effects which may result from this.

In particular, it is known that the presence of residual lactide in a PLA (or a PLGA) has a direct influence on the properties of the polymer.

This can have an impact on:
the mechanical properties of the polymer, particularly reduction of elasticity;
use. At the end of the synthesis of the polymer, generally carried out at high temperature, the residual lactide may be sublimated during extrusion and contaminate the industrial tool;
the stability of the polymer. In the presence of humidity, lactide is easily hydrolysed and the lactic acid generated, due to the local reduction of the PH, self-catalyses the decomposition of the PLA;
the formation of new by-products in formulations. The lactide can react with functions of the active principle presenting nucleophilic functions (particularly primary amine functions) to form the corresponding lactyl-lactates.

This effect is also observed in other polyesters such as, for example, polycaprolactone.

The preparation of PLAs by standard industrial processes (high temperature, without solvent and in the presence of tin salts) is inevitably accompanied by a residual lactide level of approximately 2 to 5%. The polymerisation reaction of the lactide is balanced and it is therefore impossible to consume all of the monomer.

Several techniques are known for reducing the residual lactide level of PLAs with high molecular weights. Patent application U.S. Pat. No. 5,496,923 proposes to subject the molten polymer to reduced pressure. The residual lactide is eliminated by sublimation.

In patent application EP 2 221 333, the molten polymer is swept by a dry gaseous stream which drives the residual lactide out of the reactor.

However, these two techniques present the drawback of retaining the catalyst (neutralised or not) in the final polymer.

The polymerisation catalyst can also catalyse depolymerisation, and therefore the formation of lactide.

In patent application US 2011021742, the polymer in solid state, divided into grains, is placed in contact with a solvent (particularly isopropanol), causing total consumption of the lactide. Furthermore, the addition of lactic acid also enables elimination of the catalyst.

All of these processes lead to PLAs with residual lactide levels higher than 0.2%.

WO2007/088135 discloses a process in which the polymer is solubilised in a solvent (dichloromethane, acetone) and is then re-precipitated by addition of the solution on a large volume of non-solvent (methanol, water). The solution containing the lactide is eliminated. This last method enables residual lactide levels below the detection limits (<0.01%) to be obtained and is generally used for polymers intended for pharmaceutical and medical purposes.

However, these methods present several drawbacks: use of drastic conditions (high temperatures and high vacuum) and/or large quantities of solvents.

The development of a process enabling polyesters with a low level of residual monomer to be obtained using methods which are “soft” from an economic and environmental point of view constitutes a major need.

The problem solved by the present invention is to develop an industrialisable process enabling the residual monomer level in polymers to be reduced to values below 0.1% and even below 0.06%.

The applicant therefore proposes a new polyester purification process which enables a low level of residual monomer(s) to be obtained while at the same time respecting the original properties of the polymer and proposing economically and environmentally advantageous reaction conditions.

The object of the present invention is therefore a process for purification of polyester containing impurities, these impurities containing at least 0.1% residual monomer(s) by weight of polyester. The present invention comprises at least the step of:
(ii) adding to the polyester in a solvent a functionalised material chosen from a

PAMAM dendrimer and a resin functionalised by a primary and/or secondary amine function or functions

The term “polyester” refers to a polymer of which at least one pattern contains an ester function. For example, it refers to polycaprolactones (PCL), lactic acid polymers (PLA), lactic and glycolic acid polymers (PLGA) and glycolic acid polymers (PGA).

The term “solvent” refers to any appropriate solvent or mixture of solvents. Preferably, the solvent or mixture of solvents is such that the polyester is soluble in it. Preferably, the solvent is chosen from halogenated solvents, ketones (such as acetone, methyl ethyl ketone (MEK), methyl isobutyl ketone (MIBUK)), cyclic ethers (THF, methyl THF) and aromatic solvents. For example, the solvent is chosen from dichloromethane, dichloroethane, chloroform and toluene. Preferably, the solvent is dichloromethane.

The term “impurities” refers in particular to any impurity resulting from the polyester synthesis process, for example a catalyst or a monomer which has not been consumed by the reaction.

For example, it refers to a polyester containing at least 0.1 to 1.0% impurities by total weight of polyester and preferably 0.2 to 0.5% impurities by total weight of polyester.

The term “resin” refers to any chemically stable synthetic or natural resin which can serve as a support for the spacer and/or the function(s) grafted in the present invention. For example, the resin may be a polystyrene resin, or polystyrene-divinyl benzene.

The term “functionalised resin” refers to a resin on which one or more functions are grafted, directly or via a spacer. The term “spacer” refers, for example, to a linear or branched C₁ to C₁₅ alkyl chain, or an aralkyl chain, for example a chain

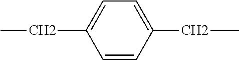

Preferably, the spacer is a linear or branched C₁ to C₁₅ alkyl chain. It also refers to a linear or branched C₁ to C₁₅ alkyl chain, or an aralkyl chain, in which one or more carbon atoms may be replaced by a nitrogen atom.

The term “aralkyl” refers to an aryl-alkyl chain or an alkyl-aryl-alkyl chain.

The term “aryl” refers in particular to a phenyl radical. The term “alkyl” refers here in particular to a linear or branched C₁ to C₁₅ alkyl chain, for example a methyl radical or an ethyl radical.

The term “primary amine” refers to an amine function in which the nitrogen atom is bonded to two hydrogen atoms. The term “secondary amine” refers to an amine function in which the nitrogen atom is bonded to a single hydrogen atom.

The term “PAMAM dendrimer” refers to a polyamide-amine dendrimer comprising primary amine functions on the surface and of a generation such that it is insoluble in the solvent in question.

Preferably, the functionalised material used in step (ii) is a resin functionalised by a primary and/or secondary amine function or functions.

Preferably, the process also comprises the steps of:
(iii) eliminating the functionalised material;
(iv) eliminating the solvent.

Step (iii) can be carried out by any known separation method appropriate for eliminating a material according to the invention. Preferably, the elimination of the material is carried out by filtration.

Step (iv) can be carried out by any known separation method appropriate for eliminating the solvent used. For example, the solvent is eliminated by vacuum evaporation.

Preferably, the invention is used for the purification of polyesters chosen from a polycaprolactone (PCL), a lactic acid polymer (PLA), a lactic and glycolic acid polymer (PLGA) and a glycolic acid polymer (PGA).

Preferably, the polyester is a lactic acid polymer (PLA) or a lactic acid and glycolic acid polymer (PLGA).

More preferably, the polyester is a polymer with a mass between 500 and 50,000 Daltons, more particularly between 1,000 and 20,000 Daltons.

Even more preferably, the polyester is a PLA.

Preferably, the functionalised material is a resin functionalised by a primary amine function or functions.

Preferably, the functionalised resin used in step (ii) has the formula (I)

S-L (I)

in which L is a linear or branched C₁ to C₁₅ alkyl chain,

in which one or more carbon atoms are replaced by a nitrogen atom, given that two successive carbon atoms cannot both be replaced by a nitrogen atom, and

given that at least one terminal carbon atom is replaced by a nitrogen atom,

and S is an appropriate support.

It is understood that the valency of the atoms is respected. For example, a —(CH₂)— group, a

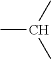

group or a —(CH₃) group of the alkyl chain may be replaced by a —(NH)—, or

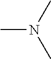

or —(NH₂) group respectively.

In all cases, it is understood that the point of attachment of L to the support S is a carbon atom.

It is also understood that two successive carbon atoms cannot both be replaced by a nitrogen atom.

Preferably, one to four carbon atoms are replaced by a nitrogen atom. Preferably, one carbon atom is replaced by a nitrogen atom. Alternatively, two carbon atoms are each replaced by a nitrogen atom. Alternatively, three carbon atoms are each replaced by a nitrogen atom. Alternatively, four carbon atoms are each replaced by a nitrogen atom.

The term “successive carbon atoms” refers to two carbon atoms bonded directly by a covalent bond.

The term “terminal carbon atom” refers to a carbon atom at the end of the chain. In the case of the linear alkyl chain —CH₂—CH₂—CH₂—CH₃, for example, it refers to the carbon atom of the CH₃ group. In the case of an alkyl chain —CH₂—CH(CH₃)₂, for example, it refers to the two carbon atoms of the CH₃ groups.

The term “appropriate support” refers, for example, to a polystyrene or polystyrene-divinyl benzene support. Preferably, it refers to a polystyrene support.

Preferably, the quantity of functionalised material added in (ii) is 2 to 10 equivalents with respect to the residual monomer, preferably 4 to 6 equivalents. Preferably, step (ii) is followed by a stirring step of 4 to 48 hours, preferably 4 to 24 hours, more preferably 15 to 20 hours.

Preferably, step (ii) (together with the preferred stirring step) is carried out at a temperature between 10 and 50° C., preferably between 15 and 25° C., preferably at ambient temperature.

Preferably, the process for purification of polyester containing impurities, these impurities also containing at least 0.1% residual acidic catalyst by weight of polyester, also comprises the step of:

(i) adding a weak base anion exchange resin to the polyester in a solvent.

The term “residual acidic catalyst” refers, for example, to a catalytic system as described in patent application WO 2004/067602. For example, the reaction is carried out in the presence of a catalyst with the formula

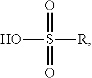

in which R represents a haloalkyl. The term “haloalkyl” refers to an alkyl radical substituted by one or more halogen atoms. The alkyl radical comprises 1 to 6 carbon atoms, preferably 1 to 4 carbon atoms. The halogen atom is chosen from F, Cl, Br and I. For example, the haloalkyl is C₂F₅ or CF₃. Preferably, the haloalkyl is CF₃.

The term “weak base anion exchange resin” refers to any type of anion exchange resin enabling the residual acidic catalyst to be eliminated. The resin is chosen, for example, from the following commercial resins: Amberlyst® A21, Dowex™ 66, Dowex Monosphere™ 66, Dowex Monosphere 77, Dowex Marathon™ WBA, Dowex Marathon WBA-2, Dowex Upcore™ Mono WB-500, Dowex M-43, Dowex M4195, Amberlite™ FPA51, Amberlite FPA53, Amberlite FPA55, Amberlite IRA67, Amberlite IRA96, Amberlite IRA96SB, Amberlite PWA7, Amberlite PWA8, Amberlite PWA10, Amberlite CR5550, IMAC HP661 or XUS 43568.00, preferably from the resins Amberlyst® A21, Dowex™ 66, Amberlite FPA53, Amberlite FPA55, Amberlite CR5550 or IMAC HP661.

Preferably, the anion exchange resin is of the tertiary amine type, i.e. the resin is functionalised by one or more tertiary amine functions. These resins enable excellent maintaining of the properties of the polyester.

The term “tertiary amine” refers to an amine function which is not bonded to any hydrogen atom.

For example, the tertiary amine type anion exchange resin is chosen from Amberlyst® A21, Dowex™ 66, Amberlite FPA53, Amberlite FPA55, Amberlite CR5550 or IMAC HP661.

For example, the resin is Amberlyst® A21.

Preferably, the resin is prepared before use in accordance with the manufacturer's recommendations. For example, the resin may be conditioned with the solvent of the mixture to be treated, for example with the dichloromethane. For example, the resin can be dried according to any traditionally used drying method, for example drying under vacuum or by washing via a solvent or mixture of solvents such as an alcohol (methanol, ethanol, 2-propanol) or a saturated hydrocarbon such as heptane.

Preferably, the anion exchange resin is then eliminated by filtration.

Preferably, step (i) is repeated a second time.

The present invention also concerns a polyester (co)polymerisation process comprising the steps of:
(a) placing the monomer(s) in contact with an acidic catalyst in a solvent;
(b) treating the obtained polyester according to step (i) as defined above;
(c) treating the obtained polyester according to steps (ii) to (iv) as defined above;

Depending on the polyester required, the reaction is carried out using a lactide monomer and a glycolide monomer, a lactide monomer alone, an ε-caprolactone monomer, or any other appropriate monomer. In one embodiment, the monomer is lactide. In another embodiment, the reaction is a copolymerisation and the reaction is carried out using lactide and glycolide.

Preferably, step (a) is carried out at a temperature between ambient temperature, i.e. approximately 25° C., and the boiling point of the chosen solvent. The reaction temperature is chosen so as to be below the decomposition temperature of the formed polymer. The formed polymers generally have a decomposition temperature between 250 and 350° C., depending on their molar mass. For example, the reaction temperature is 0 to 150° C. Preferably, the temperature is 10 to 90° C. More preferably, the temperature is 15 to 45° C., preferably 20 to 30° C. For example, the reaction is carried out at ambient temperature.

The reaction is stopped in step (b) once the required degree of polymerisation is obtained. For example, the reaction is stopped when the consumption of the initial monomer is 90 to 100%. Preferably, the reaction is stopped when the consumption of the initial monomer is greater than 94%.

The conversion rate is monitored using any method known to one skilled in the art. For example, the conversion of the initial monomer into a polymer is monitored by regular taking of a sample of solution which is concentrated, redissolved in CDCl₃ and tested by 1H NMR or UPLC.

In the present invention, the polymerisation reaction is stopped by addition of the resin according to step (i).

Preferably, the resin according to step (i) is then eliminated by filtration.

Preferably, step (i) is repeated and the anion exchange resin is again eliminated by filtration.

The filtration process according to the invention can be adapted to any polyester synthesis process presenting the same problem of residual monomer and/or catalyst.

In particular, it can be adapted to the polymer preparation processes as described in patent applications WO2012/066194, WO2012/066195 or WO2004/067602.

The following experimental part is presented to illustrate the above procedures and must in no case be considered to constitute a limit to the scope of the invention.

### EXPERIMENTAL PART

The synthesis of the polymer is carried out in solution (dichloromethane mixture (DCM/toluene) in the presence of an initiator and an acidic catalyst). At the end of the reaction, the catalyst is eliminated by treatment of the reaction medium with a basic resin (Amberlyst® 21). A step with a resin containing an amino function is therefore added. The PLA, free of catalyst and monomer, is recovered after filtration and elimination of the reaction solvents under reduced pressure.

### EXAMPLE 1

Three different resins were tested on a batch of PLA of very low molecular weight containing 0.41% residual lactide.

(2-aminoethyl)polystyrene resin (resin 1, 0.8-1.2 mmol/g)

N-(2-aminoethyl)-aminoethyl polystyrene resin (resin 2, 3.1-3.5 mmol/g)

Tris-(2-aminoethyl)-amine polystyrene resin (resin 3, 3.0 mmol/g)

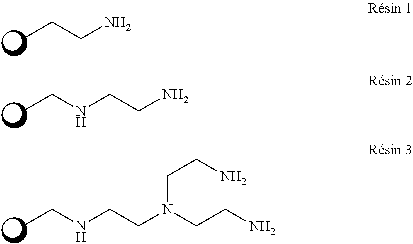

The PLA samples, in solution in a 7/3 DCM/toluene mixture, are stirred for 18 hours in the presence of four resin equivalents with respect to the quantity of residual lactide. SEC analysis of the treated polymers shows no change in the average masses. 1H NMR analysis no longer detects the lactide and confirms that the structural integrity of the PLA is maintained.

| Resin | 1 | 2 | 3 |
|---|---|---|---|
| Lactide level (%) | 0.02 | 0.11 | 0.08 |

This purification method was validated on a complete PLA synthesis process at the scale of 40 mmoles (5.76 g of lactide). At the end of the reaction, the catalyst is eliminated by two washings with the Amberlyst® 21 resin. At this point the residual lactide level is 0.40%. An additional washing with resin 1 brings the residual lactide level down to 0.03% (quantified by UPLC).

### EXAMPLE 2

One gram of PLA in solution in 10 ml of a 7/3 DCM/toluene mixture is stirred at ambient temperature in an inert atmosphere for 18 hours in the presence of 50 mg (4.0 equivalents) of resin 3 in example 1.

The resin is eliminated by filtration and the solvent is eliminated under reduced pressure to dryness.

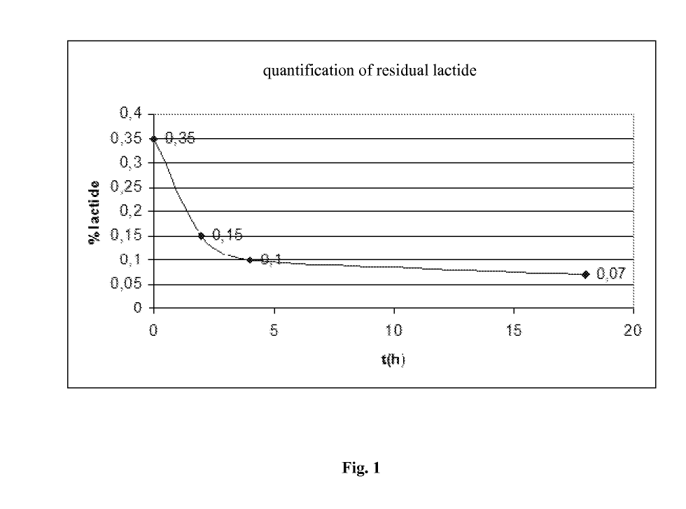

The residual lactide in the PLA is quantified by UPLC. FIG. 1 shows the lactide level as a function of the stirring time.

After 18 hours the lactide level is reduced from 0.35% to 0.07%.

The same experiment is carried out in the presence of 6 resin equivalents (75 mg for 1.0 g of PLA). After 18 hours the lactide level is slightly improved and is reduced to 0.06%.

Analysis of the samples by SEC shows no change in the average masses of the PLA after treatment by the resin (18 hours).

| | Mn (g/mol) | Mw (g/mol) | IP |
|---|---|---|---|
| Before treatment | 990 | 1170 | 1.17 |
| 4 equiv. | 980 | 1150 | 1.18 |
| 6 equiv. | 980 | 1160 | 1.18 |

1H NMR (300 MHz) analysis of the treated PLA samples does not detect lactide traces of less than 0.1 M.

The structure of the polymer is not affecting by the washing with the resin. The 1H NMR spectrum remains unchanged after the treatment

### EXAMPLE 3

A 50/50 solution of 850 mg of PLGA containing 1.0% D,L-lactide by weight (Mn=5680, PDI=1.72) in a 5/3 DCM/toluene mixture is stirred at ambient temperature for 18 hours in the presence of 75 mg (3 equivalents) of resin 2.

1H NMR (300 MHz) analysis of the PLGA sample thus treated shows a residual lactide content of less than 0.1% (NMR detection limit).

### EXAMPLE 4

The toluene and the dichloromethane are dried on an activated molecular sieve in an inert atmosphere. The lactide is recrystallised in an inert atmosphere in the distilled toluene. The dodecanol is dried under reduced pressure. The trifluoromethanesulphonic acid is distilled under vacuum. The Amberlyst® 21 resin is vacuum dried in the presence of P₂O₅ and then stored in an inert atmosphere.

Triflic acid (50 μl, 0.5 mmol) is added to a solution of lactide (4.32 g, 30.0 mmol) and dodecanol (1.86 g, 10.0 mmol) in the dichloromethane (15 ml). The reaction medium is stirred at ambient temperature for 18 hours.

1.0 g of Amberlyst 21 resin is added. The medium is then stirred for 1 hour and then filtered. 0.5 g of resin is added to the above solution. The medium is stirred for 1 hour and then filtered.

1H MNR: Correct. Detection of residual lactide

SEC Mw=957 g/mol, IP=1.18

UPLC Residual lactide level: 0.37%

The PLA solution free of catalyst is stirred with 1.5 g of PS-A-NH₂ resin (resin 1 in example 1) for 17 hours. The resin is eliminated by filtration and the solvents eliminated under reduced pressure. The PLA is then vacuum dried at 50° C. during the night (m=6.10 g, 98.7%).

1H NMR: Correct. Lactide not detectable

SEC Mw=952 g/mol, IP=1.18

UPLC Residual lactide level: 0.08%

1. Process for purification of polyester containing impurities, these impurities containing at least 0.1% residual monomer(s) by weight of polyester, comprising at least the step of:
(ii) adding to the polyester in a solvent a functionalised material chosen from a PAMAM dendrimer and a resin functionalised by a primary and/or secondary amine function or functions

2. Process according to claim 1 additionally comprising the steps of:
(iii) eliminating the functionalised material;
(iv) eliminating the solvent.

3. Process according to one of claim 1 or 2, in which the polyester is chosen from a polycaprolactone (PCL), a lactic acid polymer (PLA), a lactic and glycolic acid polymer (PLGA) and a glycolic acid polymer (PGA).

4. Process according to one of claims 1 to 3, in which the polyester is a lactic acid polymer (PLA) or a lactic acid and glycolic acid polymer (PLGA).

5. Process according to one of claims 1 to 4, in which the functionalised material is a resin, preferably a resin functionalised by a primary amine function or functions.

6. Process according to claim 5, in which the functionalised resin used in step (ii) has the formula (I)
S-L (I)
in which L is a linear or branched C₁ to C₁₅ alkyl chain or an aralkyl chain, in which one or more carbon atoms are replaced by a nitrogen atom,
given that two successive carbon atoms cannot both be replaced by a nitrogen atom, and
given that at least one terminal carbon atom is replaced by a nitrogen atom,
and S is an appropriate support.

7. Process according to claim 6, in which S is a polystyrene or polystyrene-divinyl benzene support.

8. Process according to one of claims 1 to 7, in which step (iii) is carried out by filtration.

9. Process according to one of claims 1 to 8, in which step (iv) is carried out by drying, preferably by vacuum evaporation.

10. Process according to one of claims 1 to 9 for purification of polyester containing impurities, these impurities additionally containing at least 0.1% residual catalyst by weight of polyester, additionally comprising the step of:
(i) adding a weak base anion exchange resin to the polyester in a solvent.

11. Process according to claim 10, in which step (i) is repeated a second time.

12. Process according to one of claim 10 or 11, in which the anion exchange resin is chosen from Amberlyst® A21, Dowex™ 66, Amberlite FPA53, Amberlite FPA55, Amberlite CR5550 or IMAC HP661 resin.

13. Process according to one of claims 10 to 12, in which the anion exchange resin is then eliminated by filtration.

14. Polyester (co)polymerisation process comprising the steps of:
(a) placing the monomer(s) in contact with an acidic catalyst in a solvent;
(b) treating the obtained polyester according to step (i) as defined in claims 10 to 13;
(c) treating the obtained polyester according to steps (ii) to (iv) as defined in claims 1 to 9.
